(19) United States
(12) Patent Application Publication
(10) Pub. No.: US 2024/0402002 A1
(43) Pub. Date: Dec. 5, 2024

(54) SYSTEM, CONTROL DEVICE AND SIGNAL PROCESSING METHOD TO CONVERT VIBRATION TO SOUND SIGNAL

(71) Applicant: Delmind Inc., Taoyuan City (TW)

(72) Inventors: Ding-Shian LIU, Taoyuan City (TW); Chia WANG, Taoyuan City (TW)

(21) Appl. No.: 18/512,601

(22) Filed: Nov. 17, 2023

(30) Foreign Application Priority Data
Jun. 1, 2023 (CN) 202310644720.0

(51) Int. Cl. G01H 1/12; G06F 17/14

(52) U.S. Cl. CPC G01H 1/12; G06F 17/14

(57) ABSTRACT

A system to convert vibration to a sound signal includes a vibration sensing device and a control device. The vibration sensing device is disposed on the surface of a device under test (DUT), and detects a time-domain vibration signal when the DUT is in operation. The control device receives the time-domain vibration signal, and converts the time-domain vibration signal into a sound signal. The sound signal is loaded in a computer playable audio file.

### CROSS REFERENCE TO RELATED APPLICATIONS

This application claims the benefit of China Patent Application No. 202310644720.0, filed on Jun. 1, 2023, the entirety of which is incorporated by reference herein.

### BACKGROUND OF THE INVENTION

### Field of the Invention

The present invention relates to an electronic device, and, in particular, to an electronic device for converting a vibration signal to a sound signal and the signal processing method thereof.

### Description of the Related Art

In the prior art, equipment status monitoring of reactors in the petrochemical industry usually relies on experts in the field to go to the equipment site and use a sound bar to diagnose with the human ear. The reactor uses high-temperature and high-pressure equipment with a high risk factor, and any failure may endanger the lives of experts on site. In addition, due to the continuous shortage of human resources in the petrochemical industry, it is becoming more and more difficult to inspect such resources for equipment status inspection.

### BRIEF SUMMARY OF THE INVENTION

An embodiment of the present invention provides a system to convert vibration to a sound signal. The system includes a vibration sensing device and a control device. The vibration sensing device is disposed on the surface of a device under test (DUT), and detects a time-domain vibration signal when the DUT is in operation. The control device receives the time-domain vibration signal, and converts the time-domain vibration signal into a sound signal. The sound signal is loaded in a computer playable audio file.

According to the system described above, the vibration detected by the vibration sensing device is physical vibration on an object instead of air vibration.

According to the system described above, the vibration sensing device includes a first transmission interface, a control unit, a sensor, and a first register. The first transmission interface receives a control instruction from the control device. The control unit outputs an enable signal according to the control instruction. The sensor receives the enable signal and starts to detect the time-domain vibration signal when the DUT is in operation. The first register stores the time-domain vibration signal, and sends the time-domain vibration signal to the first transmission interface, so that the time-domain vibration signal is output to the control device.

According to the system described above, the control device includes a second transmission interface, a second register, and a memory. The second transmission interface receives the time-domain vibration signal from the vibration sensing device. The second register stores the time-domain vibration signal from the second transmission interface, and outputs the time-domain vibration signal. The memory stores the time-domain vibration signal from the second register.

According to the system described above, the control device further includes a processing unit. The processing unit reads the time-domain vibration signal from the second register or the memory, and converts the time-domain vibration signal into a frequency-domain vibration signal. The processing unit performs signal processing on the frequency-domain vibration signal, and converts the frequency-domain vibration signal into a characteristic sound signal in time-domain.

According to the system described above, the control device loads the sound signal into the computer playable audio file, and stores the computer playable audio file into the memory.

According to the system described above, the control device outputs the computer playable audio file through the second transmission interface.

According to the system described above, the control device further includes a user interface and a processing unit. The user interface generates the control instruction according to a user's operation. The processing unit stores the time-domain vibration signal from the vibration sensing device into the memory. When the system is in an offline mode, after the control device receives the control instruction from the user interface, the processing unit converts the time-domain vibration signal into a sound signal.

According to the system described above, the control device further includes a user interface. The user interface generates the control instruction according to a user's operation. The processing unit stores the time-domain vibration signal from the vibration sensing device into the memory. When the system is in an offline mode, after the control device receives the control instruction from the user interface, the processing unit converts the time-domain vibration signal into the frequency-domain vibration signal, performs signal processing on the frequency-domain vibration signal, and converts the frequency-domain vibration signal into a characteristic sound signal in time-domain.

According to the system described above, the processing unit receives the control instruction, and sends the control instruction to the vibration sensing device through the second transmission interface.

According to the system described above, the signal processing includes the following stages. The processing unit amplifies the specific frequency range of the frequency-domain vibration signal to obtain a characteristic signal. The processing unit converts the characteristic signal into the characteristic sound signal in time-domain.

According to the system described above, the signal processing includes the following stage. The control device uses a digital filter to filter the time-domain vibration signal, and converts the time-domain vibration signal into a characteristic sound signal in time-domain.

According to the system described above, the signal processing includes the following stages. The processing unit amplifies the specific frequency range of the frequency-domain vibration signal to obtain a characteristic signal. The processing unit converts the characteristic signal from frequency-domain to time-domain, uses a digital filter to filter the characteristic signal, and converts the characteristic signal into the characteristic sound signal in time-domain.

According to the system described above, the DUT is a high-pressure reactor in the petrochemical industry, and the vibration sensing device is disposed on a surface of a bearing of the DUT.

According to the system described above, the bearing is selected from one or more of a motor bearing, an intermediate bearing, and a bottom bearing.

According to the system described above, the sampling rate of the sensor is equal to the characteristic frequency of the inner and outer rings of a motor shaft of the DUT, or (rpm/60)*N*n. N is a value not less than 5, rpm is the rotation speed of the motor of the DUT, and n is the number of shaft blades of the motor.

An embodiment of the present invention provides a signal processing method. The signal processing method is applicable to an electronic device comprising a vibration sensing device and a control device. The signal processing method includes the following stages. A time-domain vibration signal is detected when a device under test (DUT) is in operation. The time-domain vibration signal is converted into a frequency-domain vibration signal. Signal processing is performed on the frequency-domain vibration signal to generate a characteristic signal. The characteristic signal is converted into a characteristic sound signal. The characteristic sound signal is loaded in a computer playable audio file.

According to the signal processing method described above, the signal processing method includes the following stages. A control instruction from the control device is received. An enable signal is output according to the control instruction. Detecting the time-domain vibration signal according to the enable signal is started when the DUT is in operation. The time-domain vibration signal is stored. The time-domain vibration signal is sent to the control device.

According to the signal processing method described above, the step of performing signal processing on the frequency-domain vibration signal includes the following stages. The specific frequency range of the frequency-domain vibration signal is amplified to obtain the characteristic signal. The characteristic signal is converted into the characteristic sound signal in time-domain.

The signal processing method further includes the following stages. A digital filter is used to filter the characteristic signal after the characteristic signal is converted from frequency-domain to time-domain. The characteristic signal is converted into the characteristic sound signal in time-domain.

An embodiment of the present invention provides a control device. The control device includes a transmission interface and a processing unit. The transmission interface receives a time-domain vibration signal from a vibration sensing device. The processing unit reads the time-domain vibration signal, and converts the time-domain vibration signal into a sound signal. The sound signal is loaded in a computer playable audio file.

### BRIEF DESCRIPTION OF THE DRAWINGS

The present invention can be more fully understood by reading the subsequent detailed description and examples with references made to the accompanying drawings, wherein:

FIG. 1 is a schematic diagram of an electronic device 100 in accordance with some embodiments of the present invention.

FIG. 2 is a schematic diagram of an electronic device 200 in accordance with some embodiments of the present invention.

FIG. 3 is a schematic diagram of disposing a vibration sensing device 102 in FIG. 1 and FIG. 2 in a device under test (DUT) 300 in accordance with some embodiments of the present invention.

FIG. 4 is a flow chart of a signal processing method in accordance with some embodiments of the present invention.

FIG. 5 is a detail flow chart of a step S400 in FIG. 4 in accordance with some embodiments of the present invention.

FIG. 6 is a detail flow chart of a step S404 in FIG. 4 in accordance with some embodiments of the present invention.

FIG. 7 is a flow chart of the processing method and a waveform diagram or a spectrum diagram thereof in accordance with some embodiments of the present invention.

FIG. 8 is a flow chart of the processing method and a waveform diagram or a spectrum diagram thereof in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” and/or “include” used in the present invention are used to indicate the existence of specific technical features, values, method steps, operations, units and/or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without departing from the spirit of the present invention.

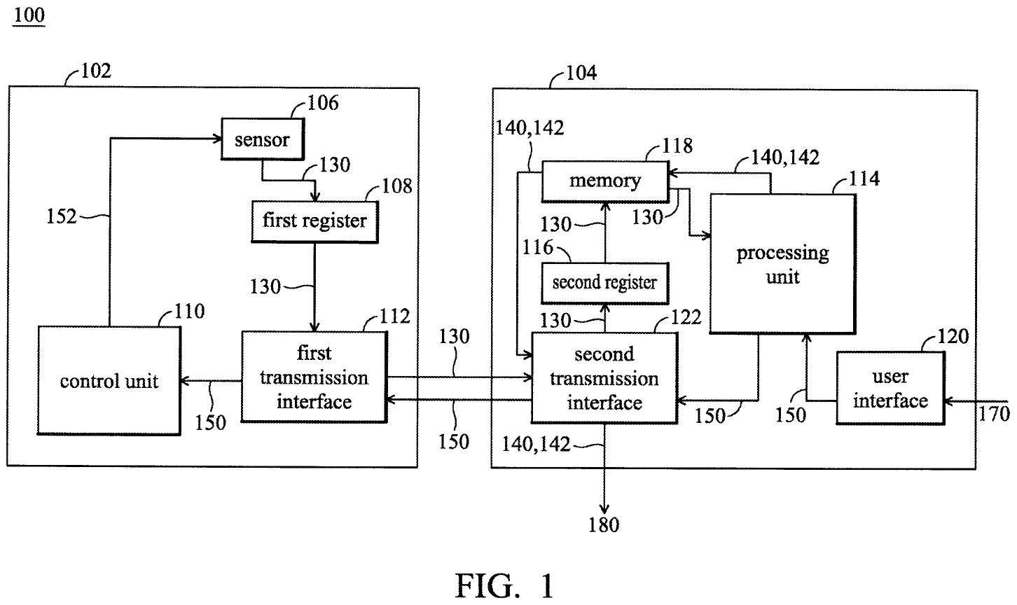

FIG. 1 is a schematic diagram of an electronic device 100 in accordance with some embodiments of the present invention. As shown in FIG. 1, the electronic device 100 includes a vibration sensing device 102 and a control device 104. In some embodiments, the vibration sensing device 102 is disposed on the surface of a device under test (DUT). The vibration sensing device 102 detects a time-domain vibration signal 130 when the DUT is in operation. In detail, the vibration sensing device 102 includes a sensor 106, a first register 108, a control unit 110, and a first transmission interface 112. In some embodiments, the first transmission interface 112 receives a control instruction 150 from the control device 104. In some embodiments, the control instruction 150 includes but not limited to sampling rate, start condition, end condition, and transmission target address of the time-domain vibration signal 130. The control unit 110 outputs an enable signal 152 according to the control instruction 150. The sensor 106 receives the enable signal 152 and starts to detect the time-domain vibration signal 130 when the DUT is in operation. In some embodiments, the DUT is a high-pressure reactor in the petrochemical industry, but the present invention is not limited thereto. The first register 108 stores the time-domain vibration signal 130, and sends the time-domain vibration signal 130 to the first transmission interface 112, so that the time-domain vibration signal 130 is output to the control device 104.

In some embodiments, the sensor 106 is a sensor related to a vibration type, such as a velocity gauge, an accelerometer, or a displacement gauge, but the present invention is not limited thereto. In some embodiments, the sampling rate of the sensor 106 is 6400 sampling points per second, but the present invention is not limited thereto. In some embodiments, the vibration detected by the vibration sensing device 102 is physical vibration on an object instead of air vibration. In other words, the vibration sensing device 102 detects the actual shaking of the DUT, rather than detecting sound waves in the air. In some embodiments, the first register 108 is a volatile memory, but the present invention is not limited thereto. In some embodiments, the control unit 110 may be, for example, a central processing unit, a microprocessor, or a microcontroller, but the present invention is not limited thereto. In some embodiments, the first transmission interface 112 is a Universal Serial Bus (USB), but the present invention is not limited thereto.

In some embodiments of FIG. 1, the control device 104 receives the time-domain vibration signal 130, converts the time-domain vibration signal 130 into a frequency-domain vibration signal, performs signal processing on the frequency-domain vibration signal, and converts the frequency-domain vibration signal into an audio signal 140. In some embodiments, the control device 104 directly performs signal processing on the time-domain vibration signal 130, but the present invention is not limited thereto. In detail, the control device 104 includes a processing unit 114, a second register 116, a memory 118, a user interface 120, and a second transmission interface 122. The second transmission interface 122 receives the time-domain vibration signal 130 from the vibration sensing device 102. The second register 116 stores the time-domain vibration signal 130 from the second transmission interface 122, and outputs the time-domain vibration signal 130. The memory 118 stores the time-domain vibration signal 130 from the second register 116. In some embodiments of FIG. 1, the processing unit 114 reads the time-domain vibration signal 130 from the memory 118. In other words, in some embodiments of FIG. 1, the control device 104 may pre-store the time-domain vibration signal 130 in the memory 118 first, and then convert the time-domain vibration signal 130 into a frequency-domain vibration signal when receiving a user instruction in the online mode or offline mode. Finally, the control device 104 may convert the frequency-domain vibration signal into the sound signal 140. In this way, the computing resources of the control device 104 can be saved, and the conversion is performed after receiving a user instruction, so that the control device 104 supports operation in offline-mode, and it can be applied to some work sites without a network environment.

In some embodiments, the memory 118 is a non-volatile memory, and the second register 116 is a volatile memory, but the present invention is not limited thereto. In some embodiments, the processing unit 114 converts the time-domain vibration signal 130 into the frequency-domain vibration signal, performs signal processing on the frequency-domain vibration signal, and then converts the frequency-domain vibration signal into the audio signal 140. In detail, the processing unit 114 performs Fast Fourier Transform (FFT) on the time-domain vibration signal 130 to obtain the frequency-domain vibration signal. In some embodiments, the processing unit 114 amplifies the specific frequency range of the frequency-domain vibration signal to obtain a characteristic signal. The processing unit 114 uses a digital filter to filter the characteristic signal after the characteristic signal is converted from frequency-domain to time-domain. Next, the processing unit 114 converts the characteristic signal, which is amplified in the specific frequency range and filtered, into a characteristic sound signal 140. The method of converting from frequency-domain to time-domain may be provided. For example, the processing unit 114 converts the frequency-domain signal into the time-domain signal through inverse Fourier transform. The method of converting the characteristic signal into the characteristic sound signal may be provided. For example, according to the format of the audio source file to be output, fill in the header with a specific format (for example, the wav format needs to add the block number, block size, file format, etc. as the header), and output it as a playable digital audio file, which is referred as the characteristic sound signal 142 here. Compared with the sound signal 140 without frequency range amplification and/or filtering, the amplified and/or filtered characteristic sound signal 142 may greatly improve the diagnostic accuracy of the DUT problems by experts in the field. In some embodiments, the digital filter may be, for example, a high-pass filter, a low-pass filter, a band-pass filter, or a band-stop filter, but the present invention is not limited thereto. It is noted that the characteristic sound signal 142 can be amplified in specific frequency ranges and filtered, or only amplified or only filtered. That is, one of amplification and filtering can be selectively performed without having to do both.

In some embodiments, the process of converting time-domain vibration signal 130 or time-domain characteristic signal into the sound signal 140 is provided. The processing unit 114 creates a wav (waveform audio file format) audio file through a Soundfile algorithm suite, and generates a header according to the data acquisition conditions of the sensor 106 and the audio file setting values (such as the number of channels, sampling frequency, etc.). The processing unit 114 writes the time-domain vibration signal 130 without signal processing, or the time-domain characteristic signal with signal processing and conversion, and generates the audio file of the computer-playable sound signal 140 or the characteristic sound signal 142. The audio file of the computer-playable sound signal 140 or the characteristic sound signal 142 is for the listener to identify the health status of the DUT (such as rotating machinery). In some embodiments, the processing unit 114 amplifies or reduces the signal within the specific frequency range of the frequency-domain vibration signal, or it performs a noise reduction algorithm to filter out noise. The noise reduction algorithm may be, for example, autoencoder, ICA, or tasnet, but the present invention is not limited thereto.

In some embodiments of FIG. 1, the processing unit 114 loads the sound signal 140 or the characteristic sound signal 142 into a computer-playable audio file, and stores the computer-playable audio file in the memory 118. The control device 104 outputs the computer-playable audio file to an external device or a cloud 180 through the second transmission interface 122. In some embodiments, the second transmission interface 122 is a Universal Serial Bus (USB), but the present invention is not limited thereto. In some embodiments, the user interface 120 generates the control instruction 150 according to the user's operation 170. In some embodiments, the user interface 120 may be, for example, a screen, a keyboard, and a mouse, but the present invention is not limited thereto. In some embodiments, the processing unit 114 receives the control instruction 150 and sends the control instruction 150 to the vibration sensing device 102 through the second transmission interface 122. The vibration sensing device 102 then receives the control instruction 150 through its first transmission interface 112.

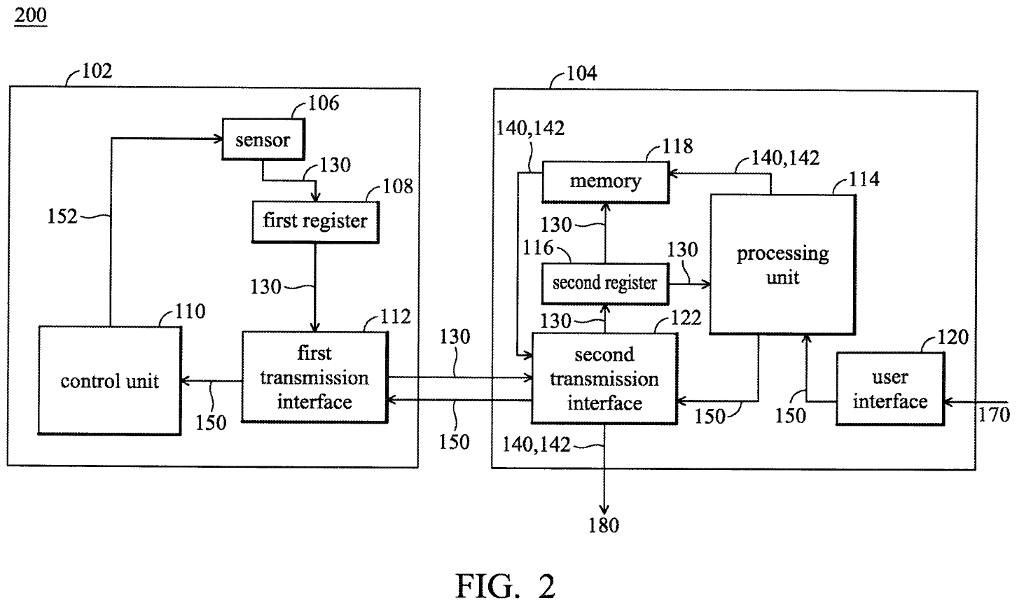

FIG. 2 is a schematic diagram of an electronic device 200 in accordance with some embodiments of the present invention. As shown in FIG. 2, the electronic device 200 includes a vibration sensing device 102 and a control device 104. In some embodiments, the vibration sensing device 102 is disposed on the surface of a device under test (DUT). The vibration sensing device 102 detects a time-domain vibration signal 130 when the DUT is in operation. In detail, the vibration sensing device 102 includes a sensor 106, a first register 108, a control unit 110, and a first transmission interface 112. In some embodiments, the first transmission interface 112 receives a control instruction 150 from the control device 104. The control unit 110 outputs an enable signal 152 according to the control instruction 150. The sensor 106 receives the enable signal 152 and starts to detect the time-domain vibration signal 130 when the DUT is in operation. The first register 108 stores the time-domain vibration signal 130, and sends the time-domain vibration signal 130 to the first transmission interface 112, so that the time-domain vibration signal 130 is output to the control device 104.

In some embodiments of FIG. 2, the control device 104 receives the time-domain vibration signal 130, converts the time-domain vibration signal 130 into a frequency-domain vibration signal, performs signal processing on the frequency-domain vibration signal, and converts the frequency-domain vibration signal into a characteristic sound signal 142. In some embodiments, the control device 104 directly performs signal processing on the time-domain vibration signal 130, but the present invention is not limited thereto. In detail, the control device 104 includes a processing unit 114, a second register 116, a memory 118, a user interface 120, and a second transmission interface 122. The second transmission interface 122 receives the time-domain vibration signal 130 from the vibration sensing device 102. The second register 116 stores the time-domain vibration signal 130 from the second transmission interface 122 and outputs the time-domain vibration signal 130. The memory 118 stores the time-domain vibration signal 130 from the second register 116. In some embodiments of FIG. 2, the processing unit 114 reads the time-domain vibration signal 130 from the second register 116. In other words, in some embodiments of FIG. 2, the control device 104 cannot operate in the offline mode. The time-domain vibration signal 130 output by the sensor 106 is stored in the second register 116 in real time for subsequent signal processing by the processing unit 114.

In some embodiments of FIG. 2, the processing unit 114 converts the time-domain vibration signal 130 into the frequency-domain vibration signal, performs signal processing on the frequency-domain vibration signal, and converts the frequency-domain vibration signal into a characteristic sound signal 142. In detail, the processing unit 114 performs Fourier transform on the time-domain vibration signal 130 to obtain a frequency-domain vibration signal. Optionally, the processing unit 114 amplifies the specific frequency range of the frequency-domain vibration signal to obtain the characteristic signal. In some embodiments, the specific frequency range may be, for example, the audio frequency range audible to the human ear, but the present invention is not limited thereto. Afterwards, optionally, the processing unit 114 converts the characteristic signal amplified in the specific frequency range from frequency-domain to time-domain (for example, through inverse Fourier transform). The processing unit 114 then uses a digital filter to filter the characteristic signal that has been converted from frequency-domain to time-domain, and finally converts the filtered characteristic signal into a characteristic sound signal 142. In some embodiments, the processing unit 114 uses a digital filter to directly filter the time-domain vibration signal 130, and converts the filtered characteristic signal into a characteristic sound signal 142, without the step of amplifying the specific frequency range.

In some embodiments of FIG. 2, the processing unit 114 loads the sound signal 140 into a computer-playable audio file, and stores the computer-playable audio file in the memory 118. The control device 104 outputs the computer-playable audio file to an external device or the cloud 180 through the second transmission interface 122. In some embodiments, the user interface 120 generates a control instruction 150 according to the user's operation 170.

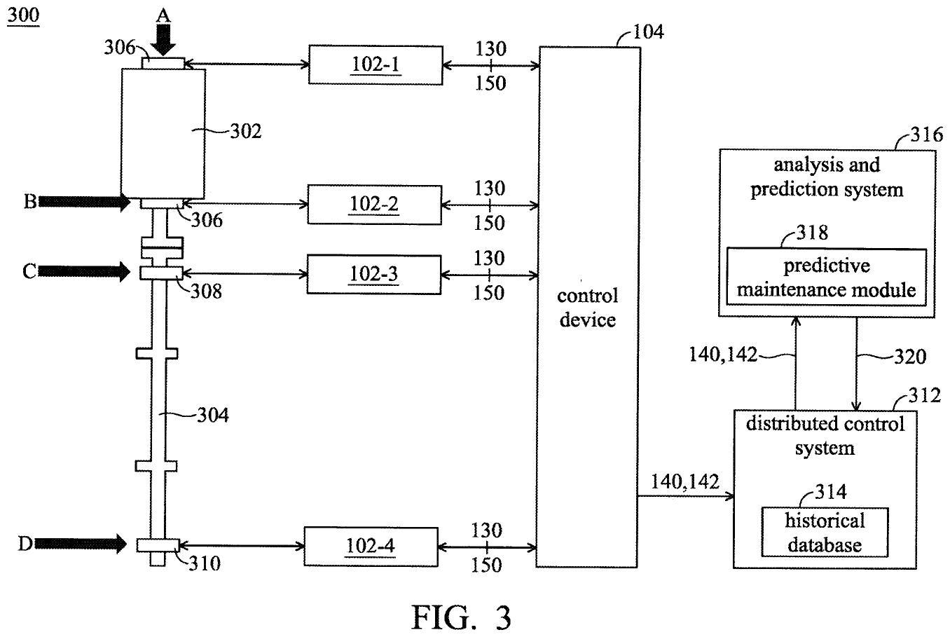

FIG. 3 is a schematic diagram of disposing a vibration sensing device 102 in FIG. 1 and FIG. 2 in a device under test (DUT) 300 in accordance with some embodiments of the present invention. In some embodiments, the DUT 300 is a high-pressure reactor in the petrochemical industry, but the present invention is not limited thereto. As shown in FIG. 3, the DUT 300 includes a motor 302 and a motor shaft 304. When the DUT 300 is in operation, the motor 302 may start to rotate, and at the same time drive the rotation of the motor shaft 304. In some embodiments, the vibration sensing device 102 of FIG. 1 and FIG. 2 may be arranged on each bearing of the DUT 300, such as the surfaces of the motor bearing 306 (positions A and B), the middle bearing (position C), and the bottom bearing (position D), but the present invention is not limited thereto. In some embodiments of FIG. 3, the motor bearing 306 at position A is located on the top of the motor 302, and the vibration sensing device 102-1 can effectively detect the vibration signal generated when the motor 302 rotates. The motor bearing 306 at position B is located where the motor 302 is physically connected to the motor shaft 304, and the vibration sensing device 102-2 can effectively detect the vibration signal generated when the motor 302 and the motor shaft 304 rotate. The intermediate bearing 308 at position

C is located in the middle of the motor shaft 304, and the vibration sensing device 102-3 can effectively detect the vibration signal generated when the motor shaft 304 rotates. Similarly, the bottom bearing 310 at position D is located at the bottom of the motor shaft 304, and the vibration sensing device 102-4 can effectively detect the vibration signal generated when the motor shaft 304 rotates.

In some embodiments of FIG. 3, the vibration sensing devices 102-1, 102-2, 102-3, and 102-4 respectively convert the vibration signals sensed by positions A, B, C, and D into the time-domain vibration signal 130, and respectively sends the time-domain vibration signal 130 to the control device 104. The control device 104 receives the time-domain vibration signal 130 from the vibration sensing devices 102-1, 102-2, 102-3, and 102-4, and converts the time-domain vibration signal 130 into an audio signal 140. In some embodiments, the vibration sensing devices 102-1, 102-2, 102-3, and 102-4 can receive the control instruction 150 from the control device 104 to start to detect the vibration signal generated when the motor shaft 304 rotates. In some embodiments of FIG. 3, the control device 104 may directly convert the time-domain vibration signal 130 into the audio signal 140, or amplify and/or filter and convert the time-domain vibration signal 130 through the above process to generate a characteristic audio signal 142. The control device 104 further outputs the sound signal 140 or the characteristic sound signal 142 to a distributed control system 312. In some embodiments, the distributed control system 312 may store the sound signal 140 or the characteristic audio signal 142 from the control device 104 into a historical database 314 in the form of a wav file. In some embodiments, the distributed control system 312 may play the sound signal 140 or the characteristic sound signal 142 for on-site experts to listen to and judge the state of the DUT 300.

In some embodiments of FIG. 3, the distributed control system 312 sends the sound signal 140 or the characteristic sound signal 142 to an analysis and prediction system 316. In some embodiments, the analysis and prediction system 316 performs a predictive maintenance module 318 to determine whether the sound signal 140 or the characteristic sound signal 142 is normal, and sends an analysis and prediction result 320 to the distributed control system 312. In some embodiments, the predictive maintenance module 318 is an artificial intelligence module or a machine learning module, but the present invention is not limited thereto. In some embodiments, in the model training procedure, the predictive maintenance module 318 uses normal sound signals and abnormal sound signals as big data during its training. The normal sound signals and abnormal sound signals are judged and marked by on-site experts after listening. The trained predictive maintenance module 318 can therefore judge whether the currently received sound signal 140 or the characteristic sound signal 142 is normal according to the training data, and output the analysis and prediction result 320 accordingly. In other words, the predictive maintenance module 318 in the analysis and prediction system 316 can compare the waveform and/or frequency of the currently received sound signal 140 or characteristic sound signal 142 according to the judgment and marking data of the on-site experts. Finally, the predictive maintenance module 318 can automatically judge whether the sound signal 140 or the characteristic sound signal 142 is normal. In other words, in some embodiments, after the audio signal 140 or the characteristic audio signal 142 stored in the historical database 314 is listened to and the status of the DUT 300 is judged and marked by experts in the field, the normal sound signal and abnormal sound signal are distinguished, and then the predictive maintenance module 318 uses the marked sound signal as data to perform the model training procedure.

In some embodiments of FIG. 3, the sampling rate of the sensor 106 in the vibration sensing device 102 satisfies the following frequency range. First, the basic frequency is equal to (rpm/60)*N. N is a value not less than 5, and rpm is the rotation speed of the motor 302. Second, a characteristic frequency of inner and outer rings of a motor shaft 304. Third, the special frequency is equal to (rpm/60)*N*n. N is a value not less than 5, rpm is the rotational speed of the motor 302, and n is the number of shaft blades of the motor 302. In some embodiments, the sampling rate of the sensor 106 is 6400 sampling points per second, but the present invention is not limited thereto.

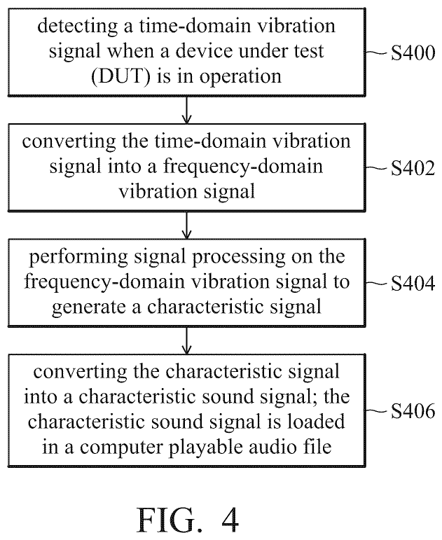

FIG. 4 is a flow chart of a signal processing method in accordance with some embodiments of the present invention. The signal processing method of the present invention in FIG. 4 is applicable to the electronic device 100 in FIG. 1 and the electronic device 200 in FIG. 2. The signal processing method includes the following stages. A time-domain vibration signal is detected when a device under test (DUT) is in operation (step S400). The time-domain vibration signal is converted into a frequency-domain vibration signal (step S402). Signal processing is performed on the frequency-domain vibration signal to generate a characteristic signal (step S404). The characteristic signal is converted into a characteristic sound signal. The characteristic sound signal is loaded in a computer playable audio file (step S406). In some embodiments, step S400 is performed by the sensor 106 in FIG. 1 and FIG. 2. Step S402, step S404, and step S406 are performed by the processing unit 114 in FIG. 1 and FIG. 2.

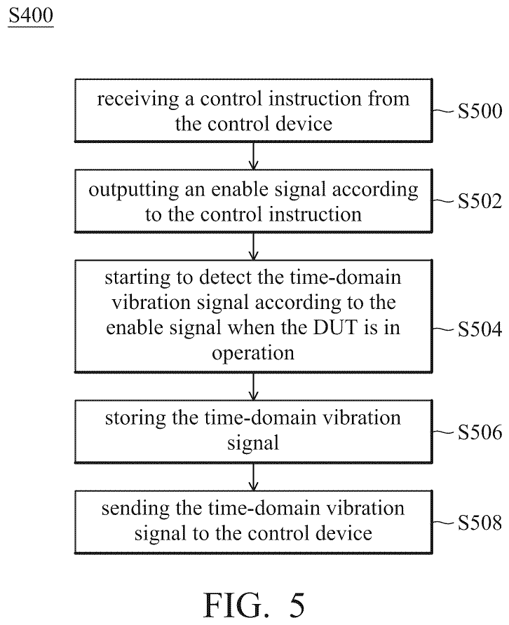

FIG. 5 is a detail flow chart of a step S400 in FIG. 4 in accordance with some embodiments of the present invention. As shown in FIG. 5, step S400 in FIG. 4 includes the following stages. A control instruction from the control device is received (step S500). An enable signal is output according to the control instruction (step S502). It is started to detect the time-domain vibration signal according to the enable signal when the DUT is in operation (step S504). The time-domain vibration signal is stored (step S506). The time-domain vibration signal is sent to the control device (step S508). In some embodiments, step S500 is performed by the first transmission interface 112 in FIG. 1 and FIG. 2. Step S502 is performed by the control unit 110 in FIG. 1 and FIG. 2. Step S504 is performed by the sensor 106 in FIG. 1 and FIG. 2. Step S506 is performed by the first register 108 in FIG. 1 and FIG. 2. Step S508 is performed by the first transmission interface 112 in FIG. 1 and FIG. 2.

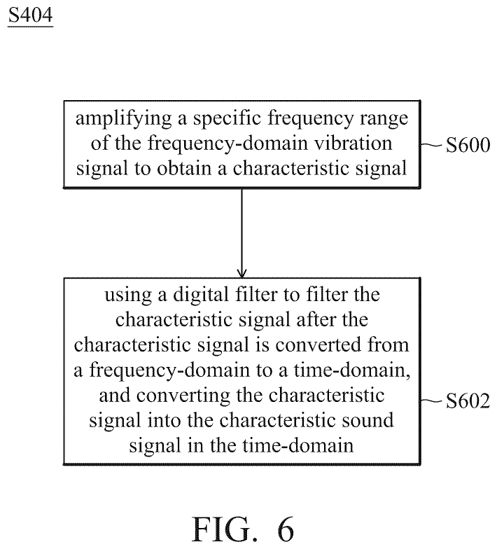

FIG. 6 is a detail flow chart of a step S404 in FIG. 4 in accordance with some embodiments of the present invention. As shown in FIG. 6, step S404 in FIG. 4 includes the following stages. The specific frequency range of the frequency-domain vibration signal is amplified (step S600). A digital filter is used to filter the characteristic signal after the characteristic signal is converted from frequency-domain to time-domain, and the characteristic signal is converted into the characteristic sound signal in time-domain (step S602). The characteristic sound signal, which are amplified and filtered in a specific frequency range and combined with a technology for converting the physical vibration signal into a sound signal as described above, may greatly improve the diagnostic accuracy of experts in the field for the problem of the DUT. In some embodiments, step S600 and step S602 are performed by the processing unit 114 in FIG. 1 and FIG. 2. In some embodiments, the signal processing method of the present invention further includes the following stages. A user interface is used to generate the control instruction. A digital filter is used to filter to obtain the filtered characteristic signal. In some embodiments, the signal processing method of the present invention converts the characteristic signal into time-domain signal for subsequent conversion into a characteristic sound signal.

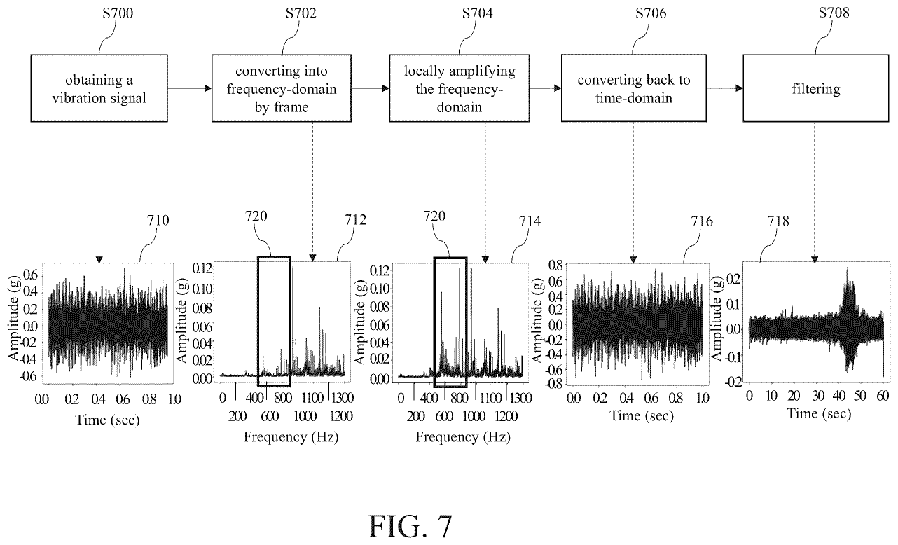

FIG. 7 is a flow chart of the processing method and a waveform diagram or a spectrum diagram thereof in accordance with some embodiments of the present invention. As shown in FIG. 7, the signal processing method includes obtaining a vibration signal (step S700), converting into frequency-domain by frame (step S702), locally amplifying the frequency domain (step S704), converting back to time-domain (step S706), and filtering (step S708). In step S700, the signal processing method of the present invention obtains a time-domain waveform diagram 710. In some embodiments, step S700 may correspond to step S400 in FIG. 4. In step S702, the signal processing method of the present invention converts the time-domain waveform diagram 710 into a spectrum diagram 712, and further processes the signal in a frequency band 720. In some embodiments, step S702 may correspond to step $402 in FIG. 4. In step S704, the signal processing method of the present invention amplifies the signal in the frequency band 720 to obtain a spectrum diagram 714. In some embodiments, step S704 may correspond to step S404 in FIG. 4 and step S600 in FIG. 6. In step S706, the signal processing method of the present invention converts the spectrum diagram 714 into a time-domain waveform diagram 716. In step S708, the signal processing method of the present invention filters the time-domain waveform diagram 716 to generate a time-domain waveform diagram 718, and finally converts the time-domain waveform diagram 718 into the characteristic sound signal 142. In some embodiments, steps S706 and S708 may correspond to step S602 in FIG. 6. In some embodiments, step S708 may be performed between step S700 and step S702, but the present invention is not limited thereto.

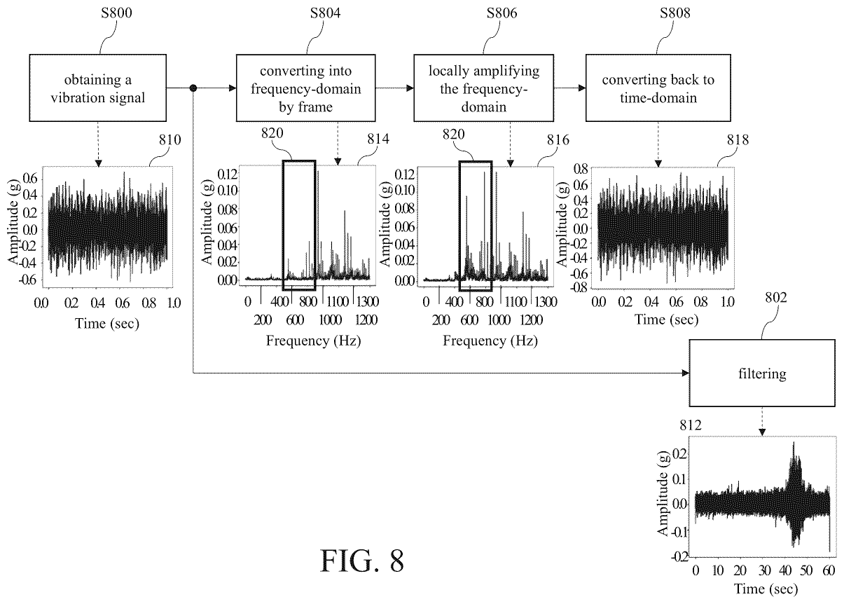

FIG. 8 is a flow chart of the processing method and a waveform diagram or a spectrum diagram thereof in accordance with some embodiments of the present invention. As shown in FIG. 8, the signal processing method of the present invention includes obtaining a vibration signal (step S800) and filtering (step S802). In step S800, the signal processing method of the present invention obtains a time-domain waveform diagram 810. In step S802, the signal processing method of the present invention filters the time-domain waveform diagram 810 to generate a time-domain waveform diagram 812. In other words, in one embodiments of the present invention, the vibration signal is directly filtered and converted into the characteristic sound signal without frequency-domain conversion or local amplification during the process.

As shown in FIG. 8, in some embodiments, the signal processing method of the present invention includes obtaining a vibration signal (step S800), converting into frequency-domain by frame (step S804), locally amplifying the frequency domain (step S806), and converting back to time-domain (step S808). In step S800, the signal processing method of the present invention obtains a time-domain waveform diagram 810. In step S804, the signal processing method of the present invention coverts the time-domain waveform diagram 810 into a spectrum diagram 814, and further processes the signal in a frequency band 820. In some embodiments, step S804 may correspond to step S402 in FIG. 4. In step S806, the signal processing method of the present invention amplifies the signal in the frequency band 820 to obtain a spectrum diagram 816. In some embodiments, step S806 may correspond to step S404 in FIG. 4 and step S600 in FIG. 6. In step S808, the signal processing method of the present invention converts the spectrum diagram 816 into a time-domain waveform diagram 818, and finally converts the time-domain waveform diagram 818 into the characteristic sound signal 142. In other words, in one embodiments of the present invention, after the frequency-domain conversion (time-domain to frequency-domain) is performed on the vibration signal, the signal is locally amplified, and finally converted into the characteristic sound signal without filtering in the process.

The electronic device 100 in FIG. 1, the electronic device 200 in FIG. 2, and the signal processing method of the present invention have the following four advantages. First, the noise of the physical vibration signal is low. Traditionally, microphones are used to collect sound on the spot, which will be greatly interfered by on-site noise (such as wind cutting sound, human voice, car sound, etc.), which may lead to misjudgment by experts when listening. However, the present invention detects physical vibration signals instead of air vibration signals (that is, the sound waves), thereby reducing the noise interference of field noise. Second, the amount of transmitted data is less than that of voice signals. The vibration signals can obtain data at a lower sampling rate for key frequency acquisition, which has a lower sampling rate than the sound signals. Third, after the vibration signals are converted into the sound signals, the characteristic signals for identifying the status of the DUT still remain. Fourth, the present invention amplifies and filters local/specific frequency sounds to make characteristic sounds more obvious and easy to identify.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system to convert vibration to a sound signal, comprising:
a vibration sensing device, disposed on a surface of a device under test (DUT), configured to detect a time-domain vibration signal when the DUT is in operation;
a control device, configured to receive the time-domain vibration signal, and convert the time-domain vibration signal into a sound signal;
wherein the sound signal is loaded in a computer playable audio file.

2. The system to convert vibration to a sound signal as claimed in claim 1, wherein the vibration detected by the vibration sensing device is physical vibration of an object instead of air vibration.

3. The system to convert vibration to a sound signal as claimed in claim 1, wherein the vibration sensing device comprises:
a first transmission interface, configured to receive a control instruction from the control device;
a control unit, configured to output an enable signal according to the control instruction;
a sensor, configured to receive the enable signal and start to detect the time-domain vibration signal when the DUT is in operation; and
a first register, configured to store the time-domain vibration signal, and send the time-domain vibration signal to the first transmission interface, so that the time-domain vibration signal is output to the control device.

4. The system to convert vibration to a sound signal as claimed in claim 3, wherein the control device comprises:
a second transmission interface, configured to receive the time-domain vibration signal from the vibration sensing device;
a second register, configured to store the time-domain vibration signal from the second transmission interface, and output the time-domain vibration signal; and
a memory, configured to store the time-domain vibration signal from the second register.

5. The system to convert vibration to a sound signal as claimed in claim 4, wherein the control device further comprises:
a processing unit, configured to read the time-domain vibration signal from the second register or the memory, convert the time-domain vibration signal into a frequency-domain vibration signal, perform signal processing on the frequency-domain vibration signal, and convert the frequency-domain vibration signal into a characteristic sound signal in time-domain.

6. The system to convert vibration to a sound signal as claimed in claim 5, wherein the control device generate the computer playable audio file based on the sound signal, and stores the computer playable audio file into the memory.

7. The system to convert vibration to a sound signal as claimed in claim 6, wherein the control device outputs the computer playable audio file through the second transmission interface.

8. The system to convert vibration to a sound signal as claimed in claim 4, wherein the control device further comprises:
a user interface, configured to generate the control instruction according to a user's operation;
a processing unit, configured to store the time-domain vibration signal from the vibration sensing device into the memory; wherein when the system is in an offline mode, after the control device receives the control instruction from the user interface, the processing unit converts the time-domain vibration signal into a sound signal.

9. The system to convert vibration to a sound signal as claimed in claim 5, wherein the control device further comprises:
a user interface, configured to generate the control instruction according to a user's operation;
wherein the processing unit stores the time-domain vibration signal from the vibration sensing device into the memory; wherein when the system is in an offline mode, after the control device receives the control instruction from the user interface, the processing unit converts the time-domain vibration signal into the frequency-domain vibration signal, performs signal processing on the frequency-domain vibration signal, and converts the frequency-domain vibration signal into the characteristic sound signal in time-domain.

10. The system to convert vibration to a sound signal as claimed in claim 5, wherein the processing unit receives the control instruction, and sends the control instruction to the vibration sensing device through the second transmission interface.

11. The system to convert vibration to a sound signal as claimed in claim 5, wherein the signal processing comprises:
the processing unit amplifies a specific frequency range of the frequency-domain vibration signal to obtain a characteristic signal; and
the processing unit converts the characteristic signal into the characteristic sound signal in time-domain.

12. The system to convert vibration to a sound signal as claimed in claim 1, wherein the signal processing comprises:
the control device uses a digital filter to filter the time-domain vibration signal, and converts the time-domain vibration signal into a characteristic sound signal in time-domain.

13. The system to convert vibration to a sound signal as claimed in claim 5, wherein the signal processing comprises:
the processing unit amplifies the specific frequency range of the frequency-domain vibration signal to obtain a characteristic signal; and
the processing unit converts the characteristic signal from frequency-domain to time-domain to obtain the characteristic sound signal; and
the processing unit uses a digital filter to filter the characteristic sound signal,.

14. The system to convert vibration to a sound signal as claimed in claim 3, wherein the DUT is a high-pressure reactor in petrochemical industry; the vibration sensing device is disposed on a surface of a bearing of the DUT.

15. The system to convert vibration to a sound signal as claimed in claim 14, wherein the bearing is selected from one or more of a motor bearing, an intermediate bearing, and a bottom bearing.

16. The system to convert vibration to a sound signal as claimed in claim 14, wherein a sampling rate of the sensor is equal to a characteristic frequency of inner and outer rings of a motor shaft of the DUT, or (rpm/60)*N*n; wherein N is a value not less than 5, rpm is a rotation speed of a motor of the DUT, and n is the number of shaft blades of the motor.

17. A signal processing method, applicable to an electronic device comprising a vibration sensing device and a control device, comprising:
detecting a time-domain vibration signal when a device under test (DUT) is in operation;
converting the time-domain vibration signal into a frequency-domain vibration signal;
performing signal processing on the frequency-domain vibration signal to generate a characteristic signal; and
converting the characteristic signal into a characteristic sound signal;
wherein the characteristic sound signal is loaded in a computer playable audio file.

18. The signal processing method as claimed in claim 17, wherein the step of detecting the time-domain vibration signal when the DUT is in operation comprises:
receiving a control instruction from the control device;
outputting an enable signal according to the control instruction;
starting to detect the time-domain vibration signal according to the enable signal when the DUT is in operation;
storing the time-domain vibration signal; and
sending the time-domain vibration signal to the control device.

19. The signal processing method as claimed in claim 17, wherein the step of performing signal processing on the frequency-domain vibration signal comprises:
amplifying the specific frequency range of the frequency-domain vibration signal to obtain the characteristic signal; and
converting the characteristic signal into the characteristic sound signal in time-domain.

20. The signal processing method as claimed in claim 17, further comprising:
using a digital filter to filter the characteristic signal after the characteristic signal is converted from frequency-domain to time-domain; and
converting the characteristic signal into the characteristic sound signal in time-domain.

21. A control device, comprising:
a transmission interface, configured to receive a time-domain vibration signal from a vibration sensing device; and
a processing unit, configured to read the time-domain vibration signal, and convert the time-domain vibration signal into a sound signal;
wherein the sound signal is loaded in a computer playable audio file.
